(19) United States
(12) Patent Application Publication
(10) Pub. No.: US 2015/0118663 A1
(43) Pub. Date: Apr. 30, 2015

(54) System and Method for Predicting and Communicating Data Relating to a Partner's Mood and Sensitivity

(71) Applicant: REVNC, INC., White Plains, NY (US)

(72) Inventors: Andrew Levy, Morristown, NJ (US); Menkin Nelson, Fort Lauderdale, FL (US)

(73) Assignee: REVNC, INC., White Plains, NY (US)

(21) Appl. No.: 14/065,357

(22) Filed: Oct. 28, 2013

(51) Int. Cl. G09B 5/02

(52) U.S. Cl. CPC G09B 5/02
USPC 434/236

(57) ABSTRACT

A system, method, and computer application is presented for predicting a partner's mood and communicating the partner's mood to a user. Particularly, the invention include identifying a partner profile which comprises a plurality of partner data provided by the user, wherein the user and the partner are involved in a relationship (preferably a romantic relationship) with one another. Further, the invention includes performing a mood evaluation, by the processor, of at least a portion of the partner data in order to predict the partner's mood at a specified current or future time. A suggestion evaluation may also be performed which is structured to identify certain data in the partner's profile (e.g., mood, menstruation cycle, like and dislikes, etc.) and generate and communicate a suggestion, advice or tip to the user in order to further facilitate the development of the romantic relationship.

### FIELD OF THE INVENTION

The present invention relates to a system, method and computer software application for predicting and communicating data relating to a partner's mood and sensitivity. More specifically, the system and method of the various embodiments are structured to analyze or process data associated with a partner's profile and predict or forecast the partner's mood at a given time. Certain embodiments further include generating a suggestion or advice based upon, for example, certain data associated with the partner's profile.

### BACKGROUND OF THE INVENTION

It is well known that a large number of modern relationships, e.g. romantic relationships, fail for a number of different reasons. When a relationship fails, however, it is oftentimes a result of a lack of understanding by each partner of the other partner, including a lack of understanding of the partner's mating patterns, cyclical behaviors, etc. Partners need to make a more concerted effort into learning about their partner, their partner's behaviors, cyclical patterns, and teaching each other about themselves.

Further, the modern individual is bombarded with a vast amount of unorganized data on a daily basis. There is a desperate need to organize the data and filter that data which is relevant to their partner in order to enhance the mutual education needed for a better relationship. There is, thus, a need for a computer-based system, method and application that can help organize the information and data needed to further a romantic relationship, and, once that information is gathered and provided in a profile, the system, method and application of the various embodiments of the proposed invention can use, evaluate and/or process the information in order to predict certain moods, behaviors, sensitivities, etc., and provide suggestions, advice and tips based thereupon.

### SUMMARY OF THE INVENTION

The present invention is generally directed to a system, method and computer program or application structured and configured to retrieve and process certain profile data in order to predict a partner's mood, fertility, and sensitivity, and in certain embodiments, to provide suggestions or advice to a user based thereupon. In addition, certain embodiments are structured to guide individuals as to what information and data to obtain, acquire and record, and to assist the individual or user in organizing and retrieving that data.

Furthermore, the system, method and application of the various embodiments of the present invention are structured and configured to identify, seek and define cyclical patterns to predict the partner's mood, sensitivity, etc. via one or more unique algorithms. With time, the present invention becomes a tutorial and guide to the cyclical behavioral patterns of both men and women. The functional synergy will help foster enhanced awareness, communication and mutual education between partners involved in a romantic or other relationship, and therefore help advance the relationship in a positive manner.

For example, in one aspect of the present invention, the system, method, and application integrates menstrual and fertility cycles with other mood and partner data (e.g., likes, dislikes, measurements, etc.) to predict and forecast the partner's mood, fertility, PMS, etc. In another aspect, the present invention integrates partner data and profile information to track and predict moods for men and women.

A periodic (e.g. daily) feedback consisting of advisory hints, suggestions, tips, etc. matched to the sensitivity, mood, and other predicted or inputted information may be provided. The moods and other profile data may be integrated into a calendar or timeline with color-coded features or icons for easy identification and prediction.

In one aspect of the present invention, the system, method and application focuses on and analyzes data provided by the user about his or her partner which minimizes or eliminates self-profiling.

Applications or profiles on or accessible by each of the partner's devices (e.g., cellular telephones, tablets, computers, etc.) may be linked with one another to promote better communication and enhanced education about one another.

These and other objects, features and advantages of the present invention will become more apparent when the drawings as well as the detailed description are taken into consideration.

### BRIEF DESCRIPTION OF THE DRAWINGS

FIG. 1 is a schematic representation of at least one embodiment of the system as provided herein.

FIG. 2 is a schematic representation at another embodiment of the system as provided herein.

FIG. 3 is a schematic representation of yet another embodiment of the system of the present invention.

FIG. 4 is block diagram of the exemplary components of a user device provided in the system of the present invention.

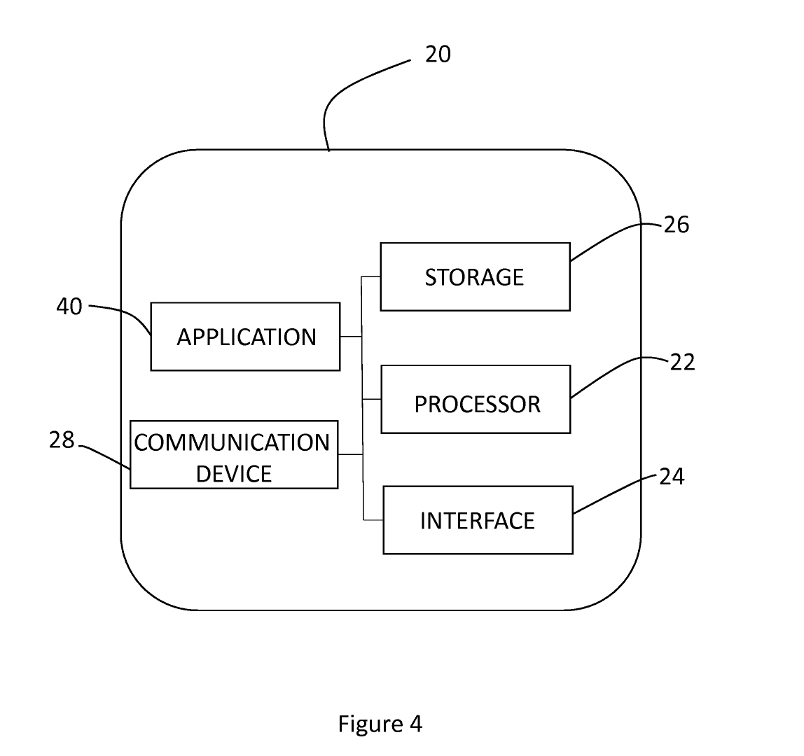

FIG. 5 is a block diagram of the exemplary components of a data management device provided in the system of at least one embodiment of the present invention.

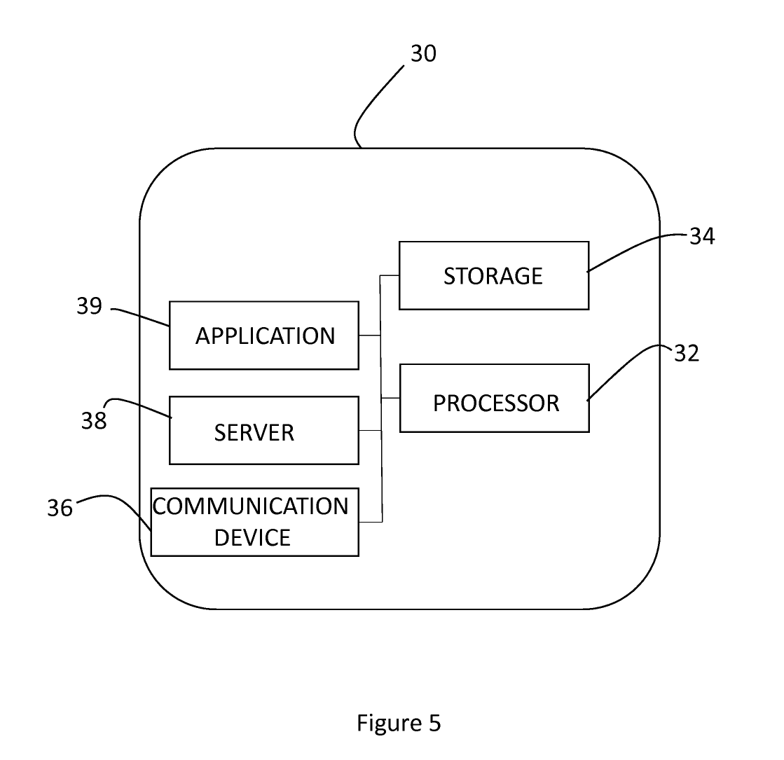

FIG. 6 is an illustration of a graphical user interface for creating a partner profile in accordance with at least one embodiment of the present invention.

FIG. 7 is an illustration of a graphical user interface for creating a partner profile, and in particular, an avatar, as described in accordance with at least one embodiment of the present invention.

FIG. 8A is an illustration of a graphical user interface presenting or displaying certain portions of a partner profile, and in particular, the likes and/or dislikes, as described in accordance with at least one embodiment herein.

FIG. 8B is an illustration of a graphical user interface for creating a portion of a partner profile, and in particular, generating the likes and/or dislikes, as described in accordance with at least one embodiment of the present invention.

FIG. 9A is an illustration of a graphical user interface presenting or displaying certain portions of a partner profile, and in particular, the measurements, as described in accordance with at least one embodiment herein.

FIG. 9B is an illustration of a graphical user interface for creating a portion of a partner profile, and in particular, generating the measurements, as described in accordance with at least one embodiment of the present invention.

FIG. 10A is an illustration of a graphical user interface presenting or displaying certain portions of a partner profile, and in particular, additional information, as described in accordance with at least one embodiment herein.

FIG. 10B is an illustration of a graphical user interface for creating a portion of a partner profile, and in particular, generating additional information, as described in accordance with at least one embodiment of the present invention.

FIG. 11 is an illustration of a graphical user interface for displaying or presenting certain portions of the partner profile and/or predicted moods or suggestions, as described in accordance with at least one embodiment of the present invention.

FIG. 12 is a high level flow chart illustrating the method of at least one embodiment of the present invention.

Like reference numerals refer to like parts throughout the several views of the drawings provided herein.

### DETAILED DESCRIPTION OF THE INVENTION

As shown in the accompanying drawings, the various embodiments of the present invention are directed to a system and method for processing or analyzing a partner's profile and, based at least partially thereupon, predicting or forecasting a partner's mood. As will be described herein, certain embodiments further include generating and communicating a suggestion or advice to a user based at least partially upon the partner's profile and an analysis or processing thereof.

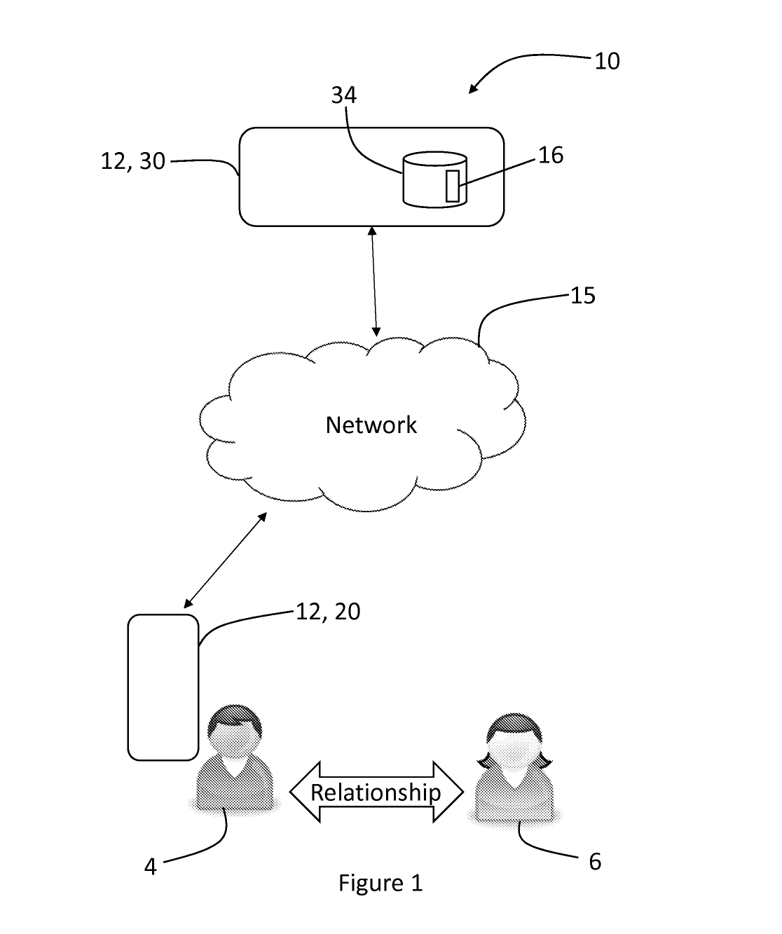

Specifically, as shown in FIGS. 1 through 3, the system 10 comprises at least one, but in some cases a plurality of, processing devices 12 structured and configured to processes and analyze various data, such as profile data, as will be described in detail herein. In particular, referring to the embodiment illustrated in FIG. 1, the system 10 may comprise a user device 20 communicatively disposed with a remote data management device 30 via a network 15.

More in particular, the user device 20 of the various embodiments comprises a processor 22, a user interface or display screen 24, a storage device 26 and a communication device or hardware 28. In various embodiments, the user device 20 may include a mobile or handheld device including, but in no way limited to a cellular telephone, media device, music or mp3 player, tablet computer, mobile gaming console, wearable media or communications devices, etc. It should also be noted that the user device 20 may also include desktop or laptop computers, or other more stationary or non-mobile devices, as well. The user device 20 of various embodiments also includes an application or program 40 either installed thereon or accessible remotely. As will be described herein, the application 40 may be used to at least partially evaluate, process, analyze, display and/or communicate various data and features described in accordance with at least one embodiment of the present invention. More in particular, the application 40 may include databases (or access to databases), knowledge bases, web enabling components, graphical user interface components, and the like. The software or application 40 provided herein includes various components or modules that are configured to facilitate operation of the present invention in the intended manner, as described in detail herein. The various components or modules, including but not limited to mood evaluation components, advice evaluation components, fertility evaluation components, data input and retrieval components, etc., are cooperatively structured and configured to facilitate implementation of the present invention and may be disposed on the user's device, locally, remotely on the data management device 30, or both.

In particular, still referring to FIG. 1, at least one embodiment of the present invention comprises a data management device 30 disposed remotely relative to the user device 20 and communicative with the user device 20 via network 15. Network 15 may thus include virtually any communication network or collection of networks capable of facilitating practice of the present invention in the intended manner, such as the World Wide Web or Internet, telecommunication networks such as 3G, 4G, LTE, etc., Intranet, Wide Area Networks, Bluetooth, Near-field Communication (NFC) networks, etc. Further, the data management device 30 may include any computer system structured to store, communicate and/or process data in accordance with the present invention, and may therefore include a computer processor 32, data storage device 34, one or more communication devices or hardware 36, and/or web server hardware/software 38. Particularly, the data management device 30 of at least one embodiment comprises web server or data server capabilities, including software and hardware to receive data requests and to communicate data via the network 15 in accordance with the present invention. It should also be noted that the data management system or device 30 of at least one embodiment may also include an application 39 which is structured and configured to at least partially process, analyze, and/or evaluate certain data in accordance with at least one embodiment disclosed herein.

Particularly, the various evaluations, processing, computing, etc. steps and methods of the present invention may be computed or otherwise processed via the application 39 and corresponding devices of the remote data management device 30 and communicated to the application 40 of the user device 20 where the information is then displayed or communicated to the user. In other embodiments, the application 40 of the user device 20 is structured to perform the evaluating, processing, computing, etc. steps herein. It should also be apparent that the various steps may be shared by the applications 39, 40 of the data management device 30 and user device 20, respectively.

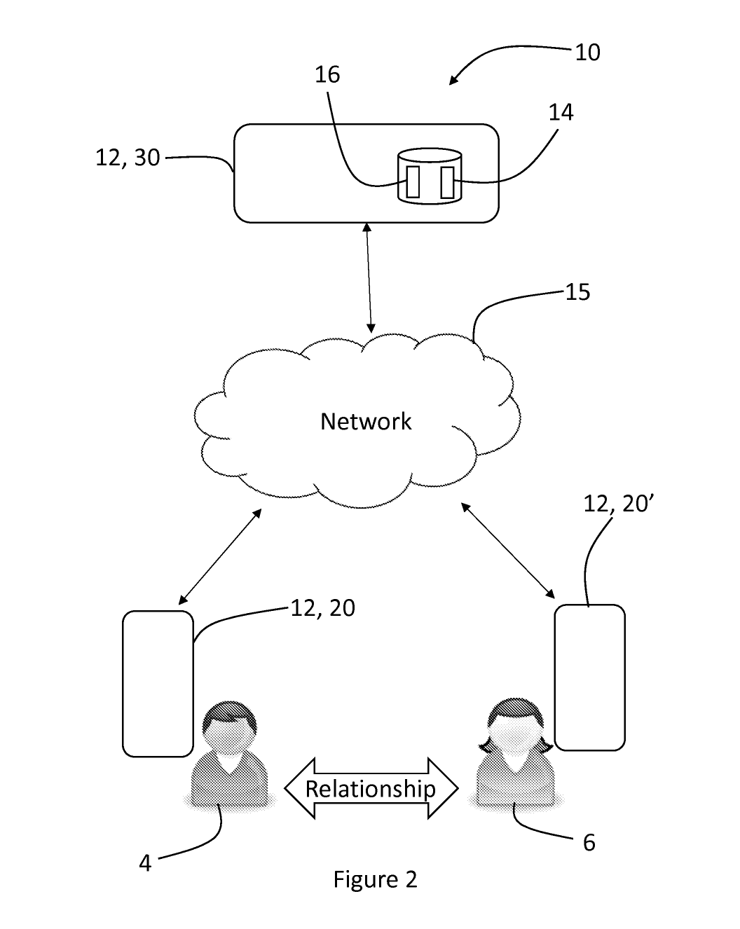

Furthermore, still referring to FIG. 1, it should be noted that user 4, of user device 20, may be involved in a relationship, preferably but not necessarily a romantic relationship, with a partner, referenced as 6. For example, user 4 and partner 6 may, but need not necessarily, be dating, engaged, married, etc. As shown in FIG. 1, one partner or user 4 may have access to the system 10 via user device 20, and thus, it is not a requirement that both partners 4, 6 enroll, sign up or access the system 10. However, as shown in FIG. 2, both partners 4, 6 may have access to user devices 20, 20′ such as their own cellular or mobile phones, tablets, computers, etc.

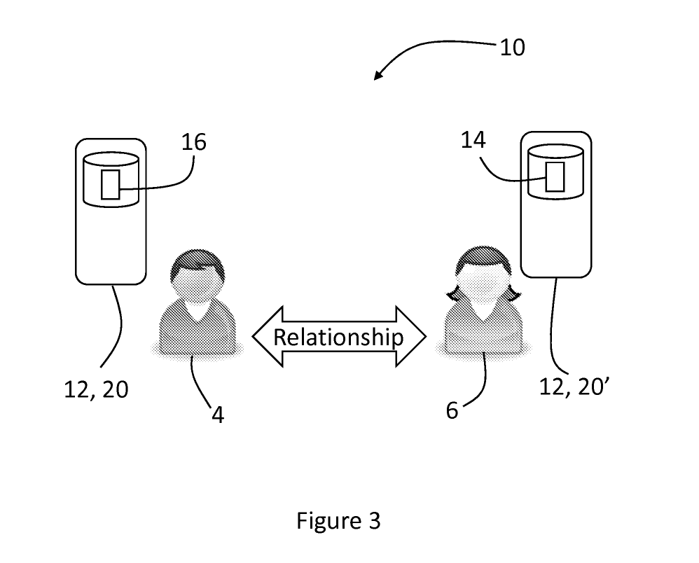

Wither reference to FIG. 3, it is shown that a remote data management system or device may not be necessary in at least one implementation of the present invention, in that all of the data storage and processing performed, as described herein, may be done by the local device(s) 20, 20′.

Further, the various embodiments of the present invention include one or more profiles 14, 16 comprising a plurality of partner data associated with the partners 4, 6. For instance, profile 16 comprises partner data corresponding to partner 6, and profile 14 comprises partner data corresponding to partner 4. In one aspect of the present invention, the user 4 of the system 10 will at least partially create his or her partner's 6 profile 16 by adding, communicating or otherwise inputting certain partner data 50 into the system via user device 20. This minimizes, and in some cases, eliminates self-profiling and can lead to more accurate and beneficial data. For instance, when the user 20 generates partner data 50 for his or her partner's profile 16, it leads to objective data which tends to be more accurate and reliable than self-profiling or data created or generated by the other partner. Accordingly, in one aspect of the present invention, the profiles 14, 16 are created, updated and maintained by the other partner.

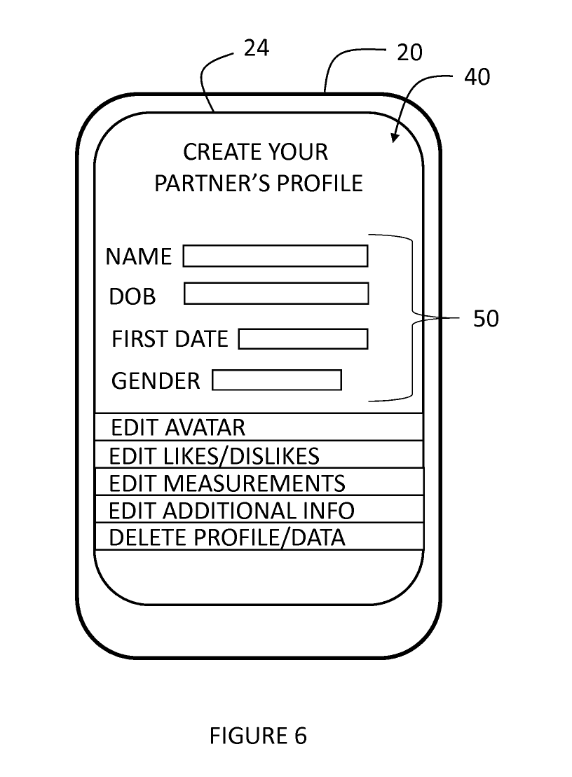

For instance, FIGS. 6 though 10B illustrate exemplary graphical user interfaces or screenshots of the application 40 of at least one embodiment described herein, wherein a user 4 may input, modify or create partner data 50 corresponding to his or her partner's profile 16. Particularly, with reference to FIG. 6, a user may create the partner's profile by entering partner data 50 corresponding to the partner's name, date of birth, gender, date of first meeting, date of first date, date of engagement, marriage, etc. Once entered, the data 50 will be saved to the partner's profile 16. The user may continue to enter profile data 50, for example, by selecting buttons/icons or navigating through the application 40.

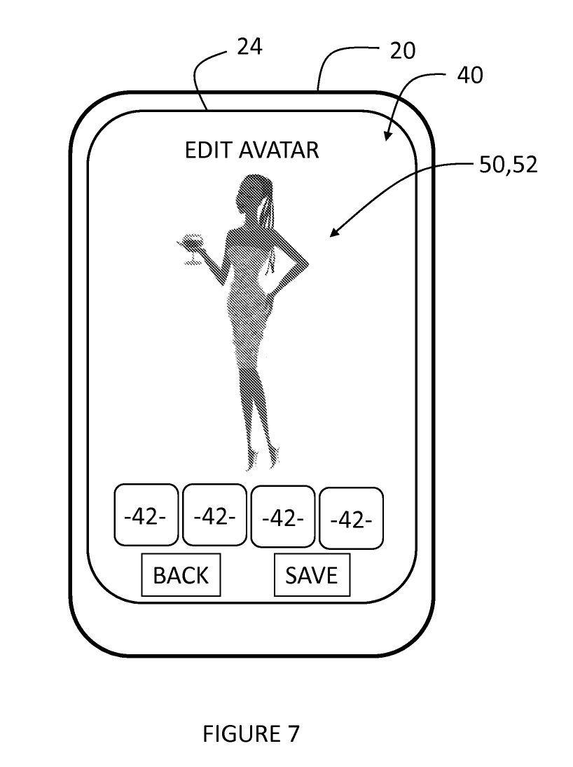

Particularly, in FIG. 7, a user may create, modify or edit an avatar 52 or icon associated with or otherwise structured to represent his or her partner 6 or his or her partner's profile 16. Specifically, the avatar 52 may be created or edit by changing or adding various aesthetic features such as gender, skin color, hair color/style, clothing, accessories, etc. These features may be added or modified via selection of one or more buttons or icons 42, for example. The avatar 52 may be interactive with gestures, such as zooming in and out, rotation, etc. In at least one embodiment, a user may be directed to a store or online service where the user may purchase additional clothing, accessories, or avatar items for the profile 16 or partner data 50 associated therewith.

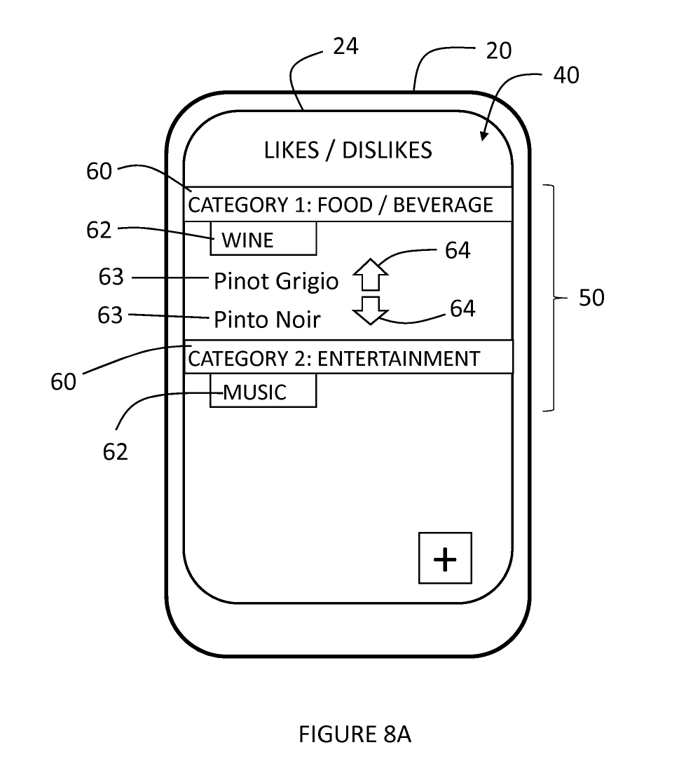

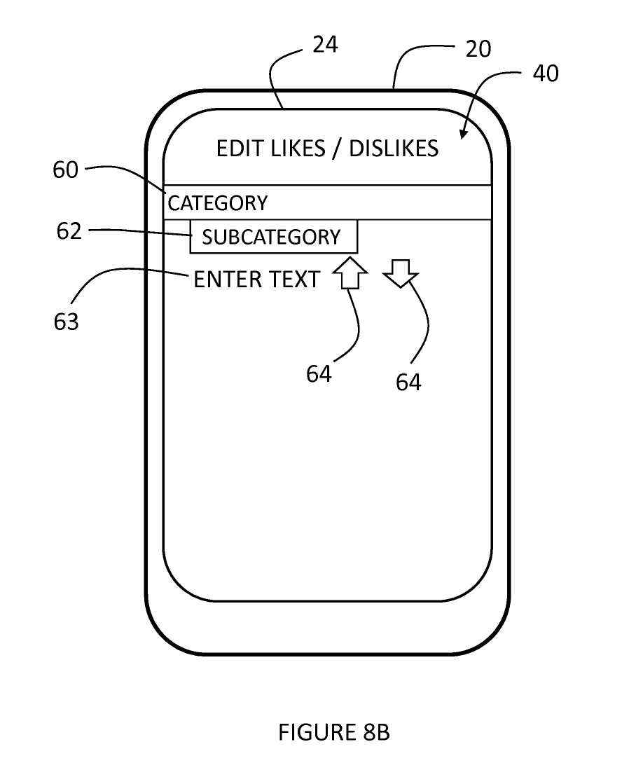

FIGS. 8A and 8B illustrate exemplary graphical user interfaces where a user can add likes or dislikes to the partner profile 16. For instance, FIG. 8A is a screenshot that displays the various likes and dislikes previously added. For exemplary purposes only, the likes/dislikes illustrated in FIG. 8A are separated by, or otherwise include, one or more levels or categories 60, 62. In particular, a general category 60 (e.g., Food/Beverage, Entertainment, etc.) may be designated or selected by the user. Other sub-categories 62 (e.g., Wine) may also be selected or designated. The likes/dislikes are then entered or positioned within the appropriate category 60 and/or sub-category 62. For instance, in the example shown, “Pinot Grigio” and “Pinot Nior” are included in the Food/Beverage category 60 and the Wine sub-category 62. Furthermore, each entry 63 is associated with an icon or other designation 64 which is configured to easily identify whether the item 63 is a like or a dislike. As shown, the icon can be an up or down arrow, although others are certainly contemplated, such as a thumb-up or thumbs-down icon, colored icons, etc. It should also be noted that the like and dislikes may be separated from one another in separate screens, lists, etc. Either way, as will be described herein, the various like/dislikes, and other partner data 50, may be processed, evaluated, and analyzed to generate a predicted mood, sensitivity and/or suggestion.

Referring now to FIG. 8B, an exemplary graphical user interface or screenshot for the user to add likes and/or dislikes is presented. Particularly, as shown, the user may enter a category 60, sub category 63, text/image 63, and designation 64. Once added, the information or data 50 will be presented on the previous display screen shown in FIG. 8A.

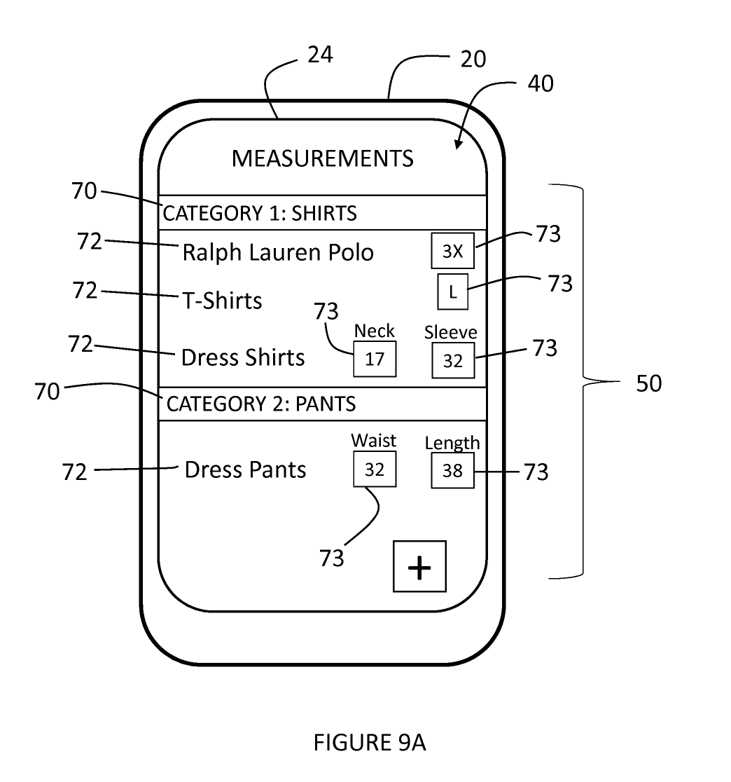

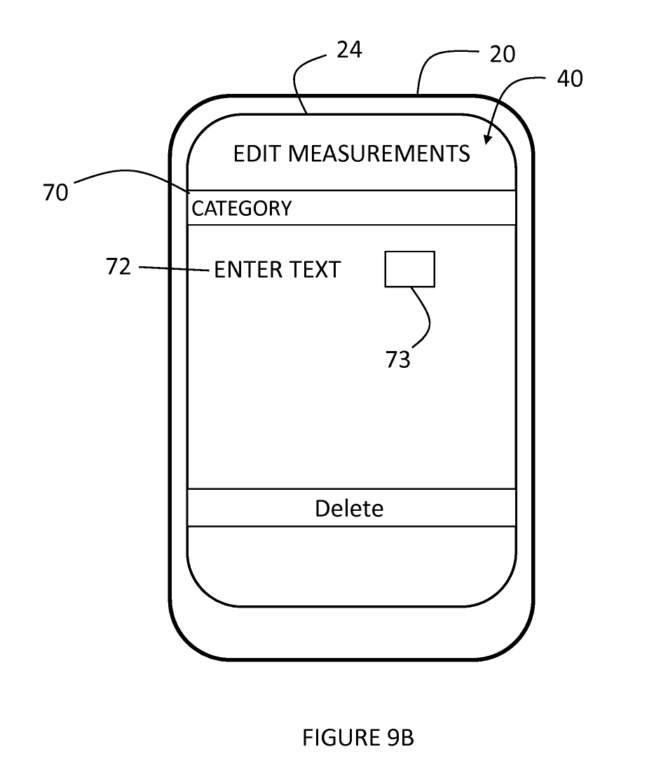

Further partner data 50 can be generated or added to the partner profile 50, including, for example the partner's measurements or clothing sizes, as illustrated in FIGS. 9A and 9B. Particularly, FIG. 9A illustrated an exemplary graphical user interface or screenshot capable of displaying the partner data 50 corresponding to the partner's measurements or clothing sizes. As an example, the data 50 may be categorized into one or more categories 70, sub-categories (not shown), etc. As illustrated, the partner data 50 corresponding to the partner's measurements includes a “Shirt” category and a “Pants” category—other categories are, of course, contemplated. For each entry 63 (e.g., “Ralph Lauren Polo,” “T-Shirts,” “Dress Shirt”), there is at least one, and in some cases more than one, size indicator or designation 73.

FIG. 9B illustrates an exemplary user interface or screenshot where a user may generate or input data 50 corresponding to the partner's measurements or clothing size. For example, the user may input or select a category 70, sub-category (not shown), etc. and enter line items 63 and corresponding size designations. The category, sub-category, items, and/or sizes may either be free text input boxes, lists, selection wheels/spinners, or other input boxes or combinations thereof.

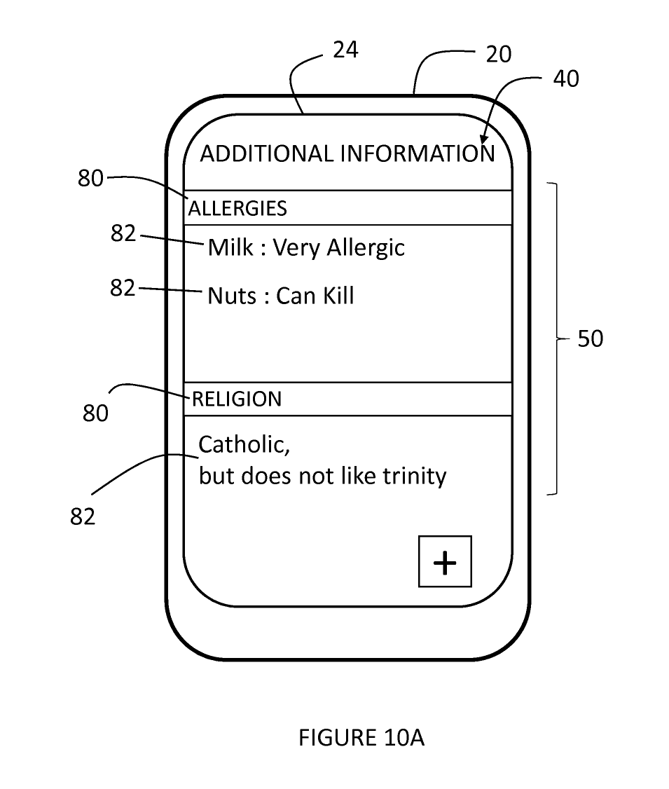

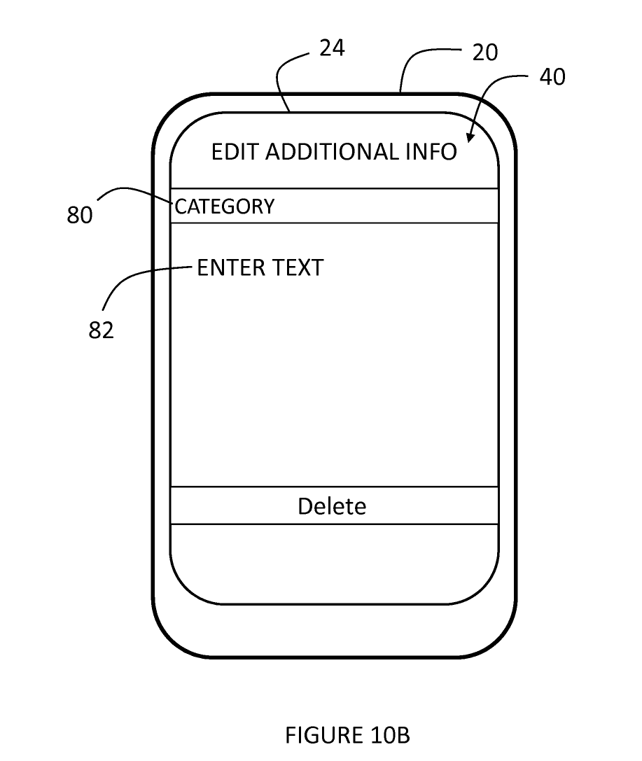

Additional information and data descriptive of or otherwise representative of the user's partner 6 can be added to the partner profile 16, including, but in no way limited to allergies, religion, medial conditions, diet preferences, political party, names of family members (e.g., mother, father, siblings, children, etc.), pets, vehicle (make, model, type, year, color), etc. FIG. 10A illustrates an exemplary user interface or screenshot structured to display additional information or data 50 corresponding to the partner's profile 16. This additional information can be grouped or categorized into one or more categories 80, sub-category (not shown), etc. FIG. 10B illustrates an exemplary input screen where a user can generate partner data corresponding to the partner's profile 16. In one embodiment, the category 80 is presented as a spinner or selection device where the user can select from pre-designated categories. Other embodiments allow the user to input any text as the category. Similarly, the item 82 may be presented as a predefined list of items that the user can select or, in certain embodiments, a free form text input box.

Certain embodiments of the present invention further include a menstruation cycle input structured to facilitate input of data corresponding to the partner's menstruation cycle. In such an embodiment, a calendar may be displayed on the user interface where a user may select or input the date(s) corresponding to the partner's menstruation cycle, and in particular, the beginning date and/or end date. Other data can also be included such as whether the partner takes or is on birth control, contraception, or fertility control device or medication.

In at least one embodiment, the processing device may be configured to evaluate the menstruation cycle data of the partner's profile and predict or forecast certain fertile, sensitive, and menstruating days of a particular day, week, month, year or other time period. For example, based upon the partner's profile data and, in particular, the menstruating cycle or data, the processing device of the present invention may calculate or predict which days the partner will be menstruation (i.e., days where the female bleeds), fertile (i.e., days where the female is highly likely to get pregnant), and sensitive (i.e., days where the female body is most sensitive to touch). As just one example, in a twenty-eight (28) day cycle, days 1-5 may be indicated as the menstruating days, days 14-19 may be indicated as the fertile days, and days 23-28 may be indicated as sensitive days. In certain embodiments, the processing device of the present invention may generate color-coded days or present icons in a calendar to indicate the various days (e.g., menstruating, fertile, sensitive, etc.) of the cycle. Furthermore, a reminder may be generated or communicated to the user to verify, input or correct the menstruation cycle to be sure that it remains accurate. As an example, the menstruation reminder may be set, generated or communicated to the user every two months, three months, four month, etc.

Certain embodiments of the present invention further allow the user to provide or input events as additional partner data, which may include, for example, reminders, dates, notes, etc., into the calendar. Some embodiments may already include some events pre-programmed or pre-designated, such as holidays, moon phases, etc. Accordingly, the events, as used herein, may include but are not limited to birthdays, holidays, first dates, date the partners met, date the partners got married, etc.

As will be described herein, the various embodiments of the present invention will predict or forecast the partner's mood, for example, based upon historical mood data, user-generated data, location information, etc. In at least one embodiment, the calendar may be color-coded based upon the partner's historical, present and/or future (predicted or forecasted) mood. Particularly, the days presented in the calendar may be color-coded, an icon or other designation may be provided on the calendar, etc.

Furthermore, certain embodiments further include partner data corresponding to special or sensitive zones on the partner's body that are sensitive to touch, pleasurable, or otherwise most desired by the partner. For example, the application 40, of one embodiment, may present an avatar representing the partner's body or a portion of the partner's body which can be selected or designated to provide input as to which portion(s) of the body are sensitive, pleasurable, desirable, or in some cases, not desirable. In at least one embodiment, the avatar or graphical representation of the partner's body may be color-coded or designated in any manner (brightness, shading, coloring, icons, etc.) to visually provide the user quick access to the selected or special zones. As with the other partner data, the processing device of the present invention may evaluate the sensitive areas or portions designated and provide one or more suggestions based thereupon, as described in detail herein.

Other embodiments further allow the user to add notes in a free text input. The notes can include virtually anything the user would like to add to the partner's profile. The processing device of at least one embodiment may then evaluate the text via text recognition algorithms and generate suggestions or forecast moods, sensitivity, etc. as provided herein.

Particularly, in at least one embodiment of the present invention, the processing device 12 is structured and configured to perform a mood evaluation of at least a portion of the various partner data in order to predict or forecast the partner's mood at a given or specified time. For instance, the processing device 12 may predict the partner's current mood or future mood at a specified time by identifying, evaluating and processing various partner data, including, but in no way limited to, the partner's past or historical moods (as entered by the user or as predicted by the system 10), the partner's menstruation cycle, the current day, the time of day, the partner's location (as entered by the user, predicted by the system 10, and/or as determined by the GPS location of the partner provided by the partner's device 20′).

In at least one embodiment, the system and method of present invention may prompt the user 4 to enter or select the partner's mood periodically, for example, multiple times a day, once a day, once every other day, once every three days, once a week, etc. The prompt or notification can be communicated by push notification, e-mail message, text message, etc. The mood selected or entered by the user may be the partner's current mood, or past mood (e.g., the partner's mood the previous day).

The mood input display, may, in at least one embodiment, include a slider or other selectable scale where the user 4 can easily select and define the partner's mood. In the case of a slider, the user 4 will slide or select a bar or icon movable along the slider to define the mood, wherein one end of the scale (e.g., far left or bottom) represents the worst mood, the oppositely disposed end (e.g., far right or top) represents the best mood, and medium moods are respectively represented throughout the middle of the slider or selectable scale. Accordingly, the mood may be saved in the partner's profile as a number or percentage represented along the slider mar, where worst mood is a 0 or 1 and the best mood is a 100. Other numerical scale can certainly be implemented.

The mood input of certain embodiments will also include a time and/or date input to correspond with the selected partner's mood. Once the mood is defined, the partner's profile or partner data will be updated accordingly to reflect the same. In one embodiment, only one mood is allowed per day, although in other embodiments, multiple moods may be defined on each day.

In one exemplary embodiment, the processing device(s) 12 may calculate, determine, predict or forecast the partner's mood based solely upon the partner's historical mood data. In one embodiment, the first 30 days includes a default value (e.g., 75% mood) for each day, or in certain embodiments, every three days. As the user inputs data, the default values may be deleted or replaced. In the case where the default values are included every third day, then there may be default value for [Cycle 1, Day 1], [Cycle 1, Day 4], [Cycle 1, Day 7], etc. For exemplary purposes only, on a thirty (30) day cycle, the following algorithm may represent the predicted current mood for the Second Cycle:
[Cycle 2, day 1]=Average of ([Cycle 1 Day 1] and [Cycle 1 Day 30]);
[Cycle 2, Day 2]=Average of ([Cycle 1, Day 1] and [Cycle 1, Day 2]) (but if [Cycle 1, Day 2] is not available, then [Cycle 2, Day 2]=Average of ([Cycle 1, Day 1] and [Cycle 1, Day 4]);
[Cycle 2, Day 3]=Average of ([Cycle 1, Day 2] and [Cycle 1, Day 3]); (but if [Cycle 1, Day 3] is not available, then [Cycle 2, Day 3]=Average of ([Cycle 1, Day 2] and [Cycle 1, Day 4]);
[Cycle 2, Day 4]=Average of ([Cycle 1, Day 3] and [Cycle 1, Day 4]);
[Cycle 2, Day 5]=Average of ([Cycle 1, Day 4] and [Cycle 1, Day 5]); (but if [Cycle 1, Day 5] is not available, then [Cycle 2, Day 5]=Average of ([Cycle 1, Day 4] and [Cycle 1, Day 7]);
[Cycle 2, Day 6]=Average of ([Cycle 1, Day 5] and [Cycle 1, Day 6]); (but if [Cycle 1, Day 6] is not available, then [Cycle 2, Day 6]=Average of ([Cycle 1, Day 5] and [Cycle 1, Day 7]);
Etc.

Accordingly, the previous algorithm is structured to calculate the mood for a selected or certain time or day based upon an average of the historical mood data, if available. If the request historical mood data is not available, then the algorithm may select from the next available mood or in certain embodiments, not use an average. For the next or third cycle, the same algorithm may be used, except data from the previous cycle [Cycle 2] would be used instead of [Cycle 1].

As more data is provided, the processing device may use more historical data to determine a more accurate mood. As an example, for the fourth cycle, the following algorithm may be used:
[Cycle 4, Day 1]=Average of ([Cycle 1, Day 1], [Cycle 2, Day 1], and [Cycle 3, Day 1];
[Cycle 4, Day 2]=Average of ([Cycle 1, Day 2], [Cycle 2, Day 2], and [Cycle 3, Day 2];
Etc.

In certain embodiments, the remaining cycles may be calculated based upon the average of the same day in the previous three cycles (as exemplified above in Cycle 4. Other embodiments, may implement further variations, for example, in Cycle 13, the mood may be calculated as follows:
[Cycle 13, Day 1]=Average of ([Cycle 1, Day 1] and [Cycle 12, Day 1]);
[Cycle 13, Day 2]=Average of ([Cycle 1, Day 2] and [Cycle 12, Day 2]);
Etc.

Similarly, the next or successive cycles may be calculated as follows:
[Cycle 14, Day 1]=Average of ([Cycle 2, Day 1] and [Cycle 13, Day 1]);
[Cycle 14, Day 2]=Average of ([Cycle 2, Day 2] and [Cycle 13, Day 2]);
Etc.

It should be noted that the above algorithm and calculations are presented for exemplary purposes only, and other calculations or algorithms may be implemented and remain within the full spirit and scope of the various embodiments of the present invention. Other factors and partner data may also be incorporated in to the calculation, algorithm or prediction, including, but certainly not limited to, the partners' current or predicted location, the partner's menstruation cycle, the partner's likes/dislikes, the current day and whether events are scheduled or listed on the calendar, etc.

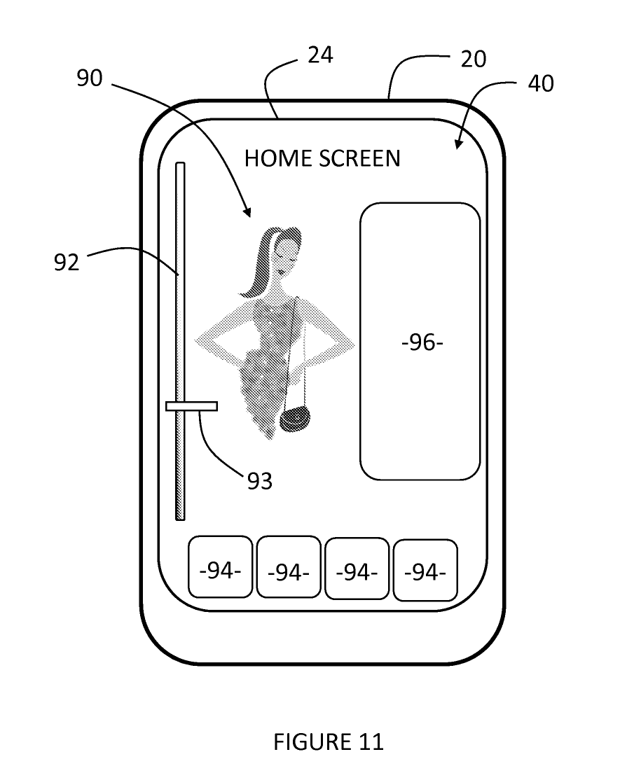

Referring now to FIG. 11, an exemplary graphical user interface or screenshot of the application 40 presented on the user interface or display screen of the user device 20 is illustrated. In particular, in one embodiment, a modular avatar 90 is shown representative of the partner and, in one embodiment, as designed and generated by the user 4 when creating the partner's profile, as described above. Specifically, the avatar 90 may, in certain embodiments, be presented in different positions, stances, or situations depending upon, for example, the partner's current mood (as either entered by the user or predicted by the present invention). As an example, if the partner's mood is determined to be bad or angry, then the avatar 90 may be displayed in a position that would indicate an angry stance (e.g., hands on this hips, angry facial expression, etc.)

Also presented by one embodiment of the application 40, and shown in FIG. 11, is a mood display bar 92, which is structured and configured to identify or display the partner's mood at a given time (e.g., currently). For instance, the mood bar 92 may include a designator 93 (such as an arrow) which is positioned along the bar 92 to represent the mood. In one exemplary embodiment, for illustrative purposes only, one end of the bar (e.g. the top) represents the best mood and the opposite end of the bar (e.g., bottom) represents the worst mood. The bar or mood display 92 may be vertically positioned or oriented, as illustrated, or disposed in other positions or orientations, as desired. Navigation items 94 may also be included, which allow the user 4 to navigate through the application 40, for example, to access the calendar, likes/dislikes page(s), measurements page(s), etc.

Also presented is an advice or suggestion area, generally represented as 96, which is structured and configured to communicate certain suggestions or advice to the user 4, based upon, for example, an evaluation of the various partner data. It should be noted that the advice or suggestions generated or otherwise provided by the system 10 or method 100 of the present invention may be communicated to the user 4 in any one or more manners, including, but not limited to, displayed in the suggestion area 96 (or other designated location) of or within the application 40, via push notification, text message, e-mail, etc.

Particularly, in at least one embodiment of the present invention, the processing device 12 is structured and configured to perform an advice evaluation on at least a portion of the partner data in order to generate or determine at least one suggestion for the user 4 and corresponding to the partner 6. For instance, certain partner data may be retrieved and/or evaluated in order to generate one or more suggestions to the user 4. In general, the suggestions are geared toward facilitating the relationship, or improving the relationship between the user 4 and the partner 6 based upon, for instance, the provided data including the partner's likes/dislikes, mood (entered, historical and/or predicted), menstruation cycle, fertility, sensitivity, measurements, current or predicted location of the user or partner, events or other calendar entries, etc.

As just an illustrative example, the suggestions or advice may include reminders as to the events on that current or selected day, how to improve the partner's mood based upon the entered partner data (e.g., likes/dislikes), etc. The application 40 may also, in certain embodiments, identify the user's current location (e.g., by virtue of GOS hardware and software located in the user device) and generate suggestions based thereupon. For example, the application 40 may recognize that the user is near a flower store and communicate a notification (based upon the partner data) that the partner likes yellow roses. If a holiday or event is upcoming (e.g. Valentine's Day, birthday, Anniversary) a suggestion may include purchasing a gift based upon the user's location, the like/dislikes, measurements, or other partner data.

Furthermore, in at least one embodiment, each of the partner's (e.g., user 4 and partner 6) may access the system and method of the present invention wherein each accesses the profile of the other partner. The profiles or devices 20, 20′ may be linked to one another such that additional information or data can be obtained, analyzed or processed. For example, the location of a partner may be used to generate suggestions or predict the moods. Specifically, as just an example, when the partner determined to be at a certain location, the mood may be affected (e.g., if the partner is at work versus at a resort). The location can be communicated to the system and processed to generate predicted moods and/or suggestions.

It is also contemplated that the partner may update or add certain items to his or her own profile, such as certain likes/dislikes, measurements, etc., rather than the user of the application entering the information. While it is generally preferred to have the user enter the information or data in order to avoid self-profiling, in certain circumstances, the partner may enter his or her own data or information, as desired.

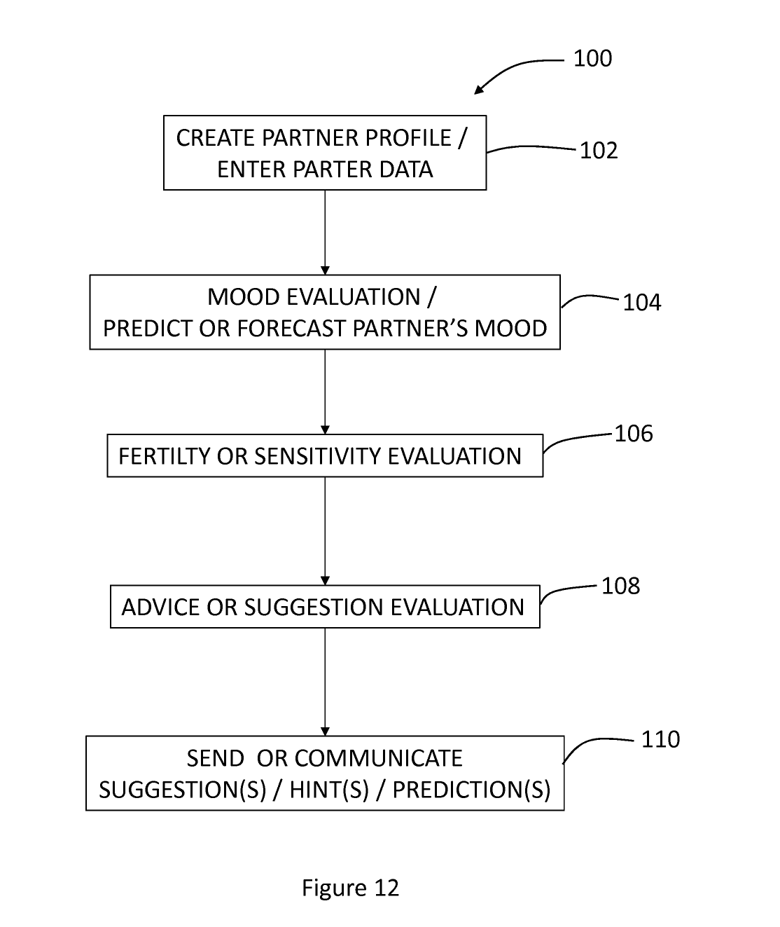

Referring now to FIG. 12, the present invention further comprises a method 100 for predicting a partner's mood and/or generating one or more suggestion, based upon, for example, partner data, as provided herein. In particular, the method 100 includes creating the partner profile by entering data, as generally represented at 102. As provided herein, the partner data may include a vast amount of information, including, but in no way limited to, the partner's likes and/or dislikes, measurements, menstruation cycle, fertility, sensitivity, historical moods, GPS location, special or sensitive zones, activities, events, dates, etc. This information may be entered by the user of the application or method of the present invention in order to avoid self-profiling. The partner data may be store in a partner profile either locally on the user's device, remotely on a data management device, or both.

Furthermore, as illustrated at 104 in FIG. 12, the method 100 of the present invention further comprises predicting and/or forecasting the partner's mood at a given or specified current or future time. For example, the mood evaluation includes retrieving, processing and analyzing the various partner data (e.g., historical mood data) in order to predict the partner's mood. The predicted mood may be for a current time or day, or for the future. As an example, the current mood may be displayed on a mood bar or via an avatar, whereas the future predicted moods may be displayed on a calendar, timeline, or list of upcoming days. In this regard, the calendar, timeline, or list of upcoming days may be presented in a color-coded display to represent different moods.

Certain embodiments of the present invention further comprise a sensitivity or fertility evaluation, as generally represented at 106 in FIG. 12. Particularly, the sensitivity or fertility evaluation may be based primarily or at least partially upon the partner's menstruation cycle, and may be varied depending on whether the partner is taking birth control, contraceptive or fertility medication or is otherwise involved in activities that may impact the fertility or sensitivity. In any event, the fertility or sensitivity evaluation include a retrieval of certain partner data and processing thereof via a given algorithm. It should be noted that the fertility evaluation or the results of the fertility evaluation may also be used to predict the partner's mood. In other words, the results of the fertility evaluation may be used in the mood evaluation, and thus the order of the stops as shown in FIG. 12 is not to be considered limiting.

Moreover, the method 100 of at least one embodiment further comprises performing a suggestion evaluation 108, which, as provided herein, includes retrieval of at least a portion of the partner data and evaluating or processing the data to determine one or more suggestions based thereupon. The suggestions are then communicated to the user, for example, via the application 40, push notification, text message, e-mail, etc., as shown at 110.

This written description of the invention provides illustrative explanation of the system and processes that make it possible to provide users with these unique benefits and insights. It may be possible to deliver equivalent benefits and insights using variations of the sequence, steps, specific embodiments and methods, without departing from the inventive concept. This description and these drawings, therefore, are to be regarded as illustrative and not restrictive.

Now that the invention has been described,

What is claimed is:

1. A method, on at least one processing device, for predicting a partner's mood and communicating the partner's mood to a user, the processing device comprising a processor, and a data storage device, the method comprising:
identifying a partner profile comprising a plurality of partner data provided by the user, the user and the partner being involved in a romantic relationship with one another,
performing a mood evaluation, by the processor, of at least a portion of the plurality of partner data to predict the partner's mood at a specified current or future time, the mood evaluation comprising retrieval and processing of information relating to the partner's historical moods, and
displaying, to the user, on a user interface, a notification corresponding to the predicted partner's mood.

2. The method as recited in claim 1 wherein the mood evaluation further comprises retrieval and processing of partner data corresponding to the specified current or future time.

3. The method as recited in claim 1 further comprising performing an advice evaluation, by the processor, of at least a portion of the partner data to determine at least one suggestion corresponding to the partner.

4. The method as recited in claim 3 further comprising communicating to the user, via the user interface, the at least one suggestion.

5. The method as recited in claim 4 wherein the advice evaluation comprises retrieval and processing of information relating to the partner's historical moods.

6. The method as recited in claim 4 wherein the advice evaluation comprises retrieval and processing of information relating to the partner's likes and dislikes.

7. The method as recited in claim 4 wherein the advice evaluation comprises retrieval and processing of partner data previously provided and entered by the user.

8. The method as recited in claim 4 wherein the advice evaluation comprises retrieval and processing of the partner's historical moods.

9. The method as recited in claim 4 further comprising performing a fertility evaluation, by the processor, of at least a portion of the partner data to predict the partner's fertility at a specified current or future time.

10. The method as recited in claim 9 wherein the advice evaluation comprises retrieval and processing of the partner's historical predicted fertility.

11. The method as recited in claim 10 wherein the advice evaluation comprises retrieval and processing of the partner's historical moods.

12. The method as recited in claim 1 further comprising displaying, to the user, on the user interface, a notification corresponding to the predicted partner's mood via a vertically-oriented, color-coded mood bar.

13. A computer program on a non-transitory computer readable medium, for execution by a computer to predict a partner's mood, the computer program comprising:
a code segment for identifying a partner profile, the partner profile comprising a plurality of partner data provided and entered by a user,
a code segment for performing a mood evaluation of at least a portion of the plurality of partner data to predict the partner's mood at a specified current or future time, comprising:
retrieving and processing of partner data corresponding to the partner's historical moods,
retrieving and processing of partner data corresponding to the specified current or future time, and
communicating to the user, via a user interface, a notification corresponding to the predicted partner's mood, and
a code segment for performing an advice evaluation of at least a portion of the plurality of partner data to determine at least one suggestion for the user corresponding to the partner, comprising:
retrieving and processing of partner data corresponding to the partner's likes and dislikes,
retrieving and processing of partner data corresponding to the partner's historical moods,
retrieving and processing of partner data corresponding to the specified current or future time, and
communicating to the user, via the user interface, the at least one suggestion.

14. The computer program as recited in claim 13 further comprising a code segment for performing a fertility evaluation of at least a portion of the plurality of partner data to predict the partner's fertility at a specified current or future time, comprising retrieving and processing partner data corresponding to the partner's menstruation cycle.

15. The computer program as recited in claim 14 wherein the code segment for performing the advice evaluation further comprises retrieval and processing of information corresponding to the partner's predicted fertility.

16. A computer system for predicting a partner's mood, comprising:
a mood evaluation component for retrieving and processing a plurality of partner data to predict a partner's mood at a specified current or future time, the mood evaluation component performing the steps of:
retrieving a processing of information relating to the partner's historical moods, and
communicating the partner's predicted mood to a user via a user interface, an advice evaluation component for determining at least one suggestion for the user, the advice evaluation component performing the steps of:
retrieving and processing partner data corresponding to the partner's likes and dislikes,
retrieving and processing of partner data corresponding to the partner's historical moods,
retrieving and processing of partner data corresponding to the specified current or future time, and
communicating to the user, via the user interface, the at least one suggestion.
